(19) United States
(12) Patent Application Publication
(10) Pub. No.: US 2025/0262573 A1
(43) Pub. Date: Aug. 21, 2025

(54) FILTER ASSEMBLY WITH FLOATING SEAL INTERFACE

(71) Applicant: Cummins Filtration Inc., Nashville, TN (US)

(72) Inventors: Wassem Abdalla, Fishers, IN (US); Vaibhav Pimpalte, Pune (IN); Hariprasad Mohan Bhalerao, Pune (IN)

(73) Assignee: Cummins Filtration Inc., Nashville, TN (US)

(21) Appl. No.: 18/857,745

(22) PCT Filed: Apr. 11, 2023
(86) PCT No.: PCT/US2023/018118

§ 371 Date: Oct. 17, 2024

(30) Foreign Application Priority Data
Apr. 20, 2022 (IN) 202241023156

(51) Int. Cl. B01D 29/13; B01D 46/24

(52) U.S. Cl. CPC B01D 29/13; B01D 46/2414; B01D 2201/295; B01D 2201/347; B01D 2265/028

(57) ABSTRACT

A filtration system having a floating seal interface is provided. The filtration system includes a filter housing having a shell and a filter head. The filtration system also includes a filter element positioned within the filter housing. The filter element includes a filter media and a first endplate positioned at a filter media first end. The first endplate includes a first endplate first portion and a first endplate second portion. The first engagement structure couples the first endplate second portion to the first endplate first portion such that the first endplate first portion is movable relative to the first endplate second portion while remaining coupled to the first endplate second portion.

### CROSS-REFERENCE TO RELATED CASES

This application is a National Phase Application based on PCT Application No. PCT/US2023/018118, filed Apr. 11, 2023, which claims the benefit of Indian Patent Application number 202241023156, filed on Apr. 20, 2022, entitled FILTER ASSEMBLY WITH FLOATING SEAL INTERFACE. The contents of these applications are incorporated herein by reference in their entirety.

### TECHNICAL FIELD

The present invention generally relates to the field of filtration systems.

### BACKGROUND

Internal combustion engines generally combust a mixture of fuel (e.g., gasoline, diesel, natural gas, etc.) and air. Lubrication oil is also supplied to the engine to lubricate the various moving components of the engine. Either prior to entering the engine or during engine operation, the intake air, fuel, lubrication oil, and/or other fluids are typically passed through filtration systems to remove contaminants (e.g., dust, water, oil, etc.) from the fluids. The filtration systems include filter elements having filter media. As the fluid passes through the filter media, the filter media removes at least a portion of the contaminants in the fluid. One or more sealing members (e.g., gaskets, O-rings, etc.) may be used to separate the filtered fluid from the un-filtered fluid.

### SUMMARY

An example embodiment relates to a filtration system. The filtration system includes a filter housing having a shell and a filter head. The filtration system also includes a filter element positioned within the filter housing. The filter element includes a filter media and a first endplate positioned at a filter media first end. The first endplate includes a first endplate first portion and a first endplate second portion. The first endplate second portion includes a first engagement structure that couples the first endplate second portion to the first endplate first portion such that the first endplate first portion is movable relative to the first endplate second portion while remaining coupled to the first endplate second portion.

Another example embodiment relates to a filter element. The filter element includes a filter media and a first endplate positioned at a filter media first end. The first endplate includes a first endplate first portion and a first endplate second portion. The first endplate second portion includes a first engagement structure that couples the first endplate second portion to the first endplate first portion such that the first endplate first portion is moveable relative to the first endplate second portion while remaining coupled to the first endplate second portion.

Still another example embodiment relates to an endplate for a filter element. The endplate comprises an endplate first portion comprising a rib that extends radially from a center of the endplate first portion to an edge of the endplate first portion. The endplate further comprises an endplate second portion. The endplate second portion comprises a first wall extending away from a top surface of the endplate second portion and towards a bottom surface of the endplate first portion, and a second wall extending away from the top surface of the endplate second portion and above the endplate first portion. The second wall has a groove that is sized to receive a portion of the rib such that the endplate first portion is coupled to the endplate second portion and the endplate first portion is movable relative to the endplate second portion while remaining coupled to the endplate second portion.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a sectional view of a filtration system, according to an example embodiment.

FIG. 2A is a perspective view of a filter element for use in the filtration system of FIG. 1, according to an example embodiment.

FIG. 2B is a cutaway perspective view of the filter element of FIG. 2A.

FIG. 3A is a sectional view of a first endplate for use with the filter element of FIG. 2A.

FIG. 3B is a detailed perspective view of the filter element of FIG. 2A showing the first endplate.

FIG. 4A is a first sectional view of the filter element of FIG. 2A.

FIG. 4B is a first detailed sectional view of the filter element of FIG. 2A showing a first engagement feature.

FIG. 5A is a second sectional view of the filter element of FIG. 2A.

FIG. 5B is a second detailed sectional view of the filter element of FIG. 2A showing a first engagement feature.

FIG. 6A is a perspective view of a first portion of the first endplate of FIG. 3A.

FIG. 6B is a perspective view of a second portion of the first endplate of FIG. 3A.

FIG. 6C is a perspective view of the filter element of FIG. 2A shown in a disassembled state.

FIG. 7 is a sectional view of a filtration system, according to another example embodiment.

FIG. 8A is a perspective view of a filter element for use with the filtration system of FIG. 7, according to an example embodiment.

FIG. 8B is a cutaway perspective view of the filter element of FIG. 8A.

FIG. 8C is a detailed perspective view of the filter element of FIG. 8A, showing a first endplate.

FIG. 9A is a sectional view of a first endplate for use with the filter element of FIG. 7.

FIG. 9B is a sectional view of the filter element of FIG. 8A.

FIG. 10A is a perspective view of a first portion of the first endplate of FIG. 9A.

FIG. 10B is a perspective view of a second portion of the first endplate of FIG. 9A.

FIG. 10C is a perspective view of the filter element of FIG. 8A shown in a disassembled state.

FIG. 11A is a perspective view of a filter element, according to still another example embodiment.

FIG. 11B is a cutaway perspective view of the filter element of FIG. 11A.

FIG. 12A is a sectional view of the filter element of FIG. 11A.

FIG. 12B is a detailed sectional view of the filter element of FIG. 11A showing a first engagement feature.

FIG. 13A is a perspective view of a first portion of a first endplate for use with the filter element of FIG. 11A.

FIG. 13B is a perspective view of a second portion of the first endplate for use with the filter element of FIG. 11A.

FIG. 13C is a perspective view of the filter element of FIG. 11A shown in a disassembled state.

FIG. 14 is a sectional view of a filtration system, according to yet another example embodiment.

FIG. 15A is a detailed perspective view of a filter element for use with the filtration system of FIG. 14, according to an example embodiment.

FIG. 15B is a sectional view of the filter element of FIG. 15A.

FIG. 16A is a perspective view of a first portion of a first endplate for use with the filter element of FIG. 15A.

FIG. 16B is a perspective view of a second portion of the first endplate for use with the filter element of FIG. 15A.

FIG. 16C is a perspective view of the filter element of FIG. 15A shown in a disassembled state.

### DETAILED DESCRIPTION

Referring to the figures generally, a filtration system having a floating seal interface is described. In the filtration system, a sealing member forms a seal between filter housing components (e.g., a shell housing, a filter mounting head, etc.). A filter element is positioned within the filter housing components. The filter element includes an endplate that at least partially positions the sealing member within the filter housing components such that the seal is formed therebetween. The endplate of the filter element advantageously enables the seal member to be axially un-aligned with the other components of the filter element, such that the seal member is axially aligned with the filter housing components, even if the filter element is not axially aligned with the filter housing components.

In some arrangements, the filter element includes an interlocking interface for positioning the filter element within the filter housing components. As will be appreciated, if a non-authorized filter element lacking the matching interlocking interface pattern is attempted to be installed in or on the filter housing component, the non-authorized filter element may not fit against the filter housing component. Accordingly, the interlocking interface prevents non-authorized filter elements from being installed in the filtration system. Additionally, the interlocking interface may prevent the filter element from freely rotating with respect to the filter housing component of the filtration system.

The embodiments shown and described in further detail herein below relate to an inside-out flow design for a filtration system. It should be understood that the embodiments described herein may be utilized in other filtration systems. For example, the embodiments described herein may be utilized in an outside-in flow design and/or any other type of filtration system. Additionally, the filtration system, including the filter element, may include more or fewer components than as shown in the Figures. Accordingly, references to various components being within, downstream, exterior, upstream, and the like are relative to the embodiments shown in Figures, and it should be understood that other embodiments, such as an outside-in flow design for a filtration system, may have the same or similar components provided in a different arrangement.

### Filtration System

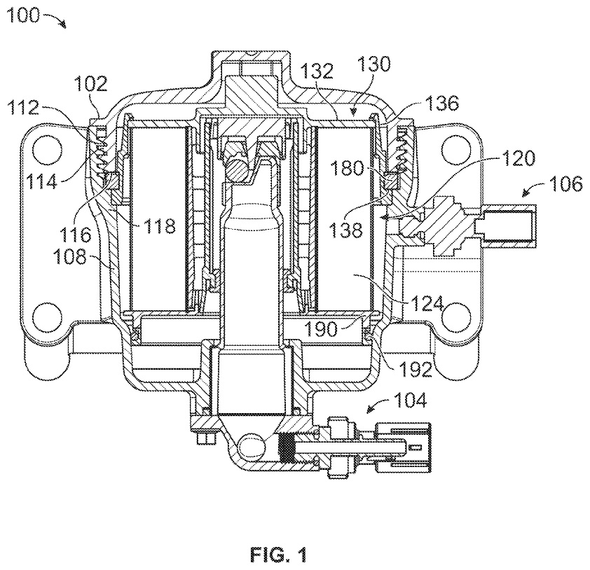

FIG. 1 is a sectional view of a filtration system 100, according to an example embodiment. The filtration system 100 is configured to provide a filtered fluid to a downstream device such as an engine. As shown, the filtration system includes one or more filter housing components including a cover or filter head 102 and a shell 108. The filtration system 100 also includes a filter element 120. It should be understood that the filtration system 100 may include more or fewer components than as shown in FIG. 1.

The filter head 102 is coupled to the shell 108. As shown, the filter head 102 includes one or more filter head threads 112 that threadably couple to one or more shell threads 114 of the shell 108. The filter head 102 includes a filter head sealing surface 116, and the shell 108 includes a shell sealing surface 118. The filter head sealing surface 116 and the shell sealing surface 118 at least partially define a cavity for a seal member 180. The seal member presses against the filter head sealing surface 116 and the shell sealing surface 118 forming a seal therebetween, substantially preventing a fluid from flowing between the filter head 102 and the shell 108.

The filtration system 100 may include one or more ports shown as a first port 104 and a second port 106. One of the first port 104 and the second port 106 may be an inlet port in fluid receiving communication with an upstream component and fluid providing communication with the filter element 120. The other of the first port 104 and the second port may be an outlet port in fluid receiving communication with the filter element 120 and in fluid providing communication with a downstream component, such as an engine. For example, the first port 104 may be the inlet port and the second port 106 may be the outlet port, or vice versa.

### Snap Fit Feature

Still referring to FIG. 1, the filter element 120 is configured to filter a fluid (e.g., by removing contaminants). In some embodiments, the filter element 120 is removably coupled to the shell 108. In other embodiments, the filter element 120 is permanently secured within the shell 108 such that the filter element 120 cannot be removed from the shell 108 without causing damage to the filter element 120 and/or the shell 108. The filter element 120 is at least partially contained within the shell 108 and/or the filter head 102.

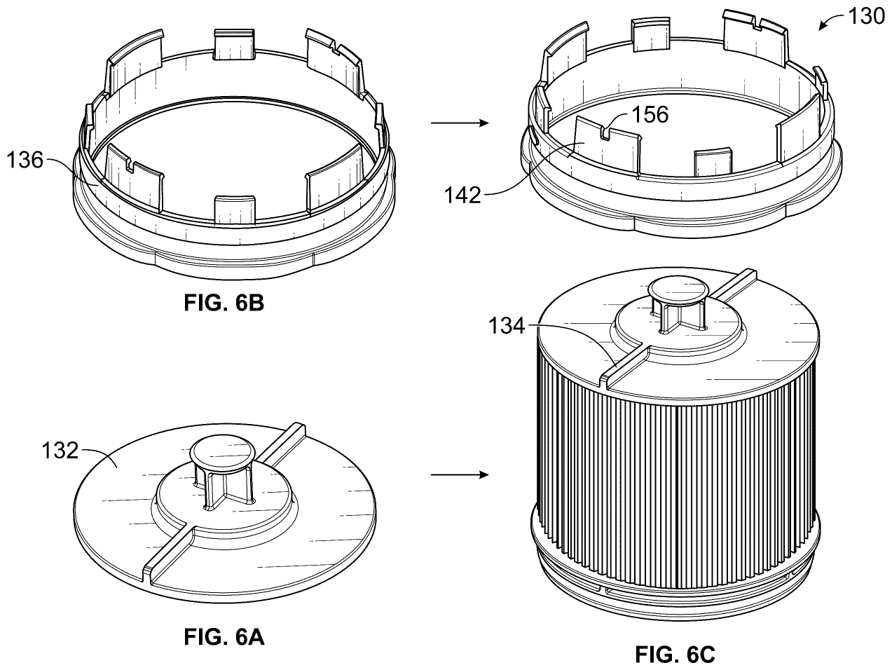

As shown, the filter element 120 includes a filter media 124, a first endplate 130, and a second endplate 190. The filter media 124 may be fitted between the first endplate 130 and the second endplate 190. In an example arrangement, the filter media 124 is embedded to the first endplate 130 by an embedding process described herein with respect to FIG. 6B. The filter media 124 may be similarly embedded to the second endplate 190. In various embodiments, the filter media 124 may be formed in a cylindrical or annular configuration. The filter media 124 may be pleated to increase surface area. The filter media 124 may be a single-layer media or a multi-layer media. The filter media 124 may be made from at least one of a woven fiber, a non-woven material, a wet laid material, a polymeric material, a glass material, a cellulose material, and/or other suitable material. The filter media 124 is structured to allow the unfiltered fluid to be filtered by flowing through the filter media 124. For example, the unfiltered fluid flows through the filter media 124, and the filter media 124 removes impurities such as particulates, organic matter, and the like, from the unfiltered fluid as the unfiltered fluid passes through the filter media 124. The impurities are trapped by the filter media 124. The filter media 124 may also at least partially separate different types of fluid (e.g., separating water from fuel). It should be understood that the filter element 120 may include additional or different filter media than shown in FIG. 1. For example, the filter element 120 may include a second filter media, a coalescing media for coalescing water, and/or other filter media.

The first endplate 130 is positioned at a first end of the filter media 124. The first endplate 130 is shown to include a first endplate first portion 132 and a first endplate second portion 136. As described in more detail below, the first endplate first portion 132 is removably coupled to the first endplate second portion 136. The first endplate second portion 136 includes a first endplate sealing surface 138 that at least partially defines a cavity for the seal member 180. In some embodiments, the seal member 180 may press against the endplate sealing surface 138 and form a seal between the first endplate 130 and the filter head 102 and/or the shell 108. The second endplate 190 is positioned at a second end of the filter media 124, opposite the first end of the filter media 124. The second endplate 190 may include a second seal member 192 that forms a radial seal between the second endplate 190 and the shell 108.

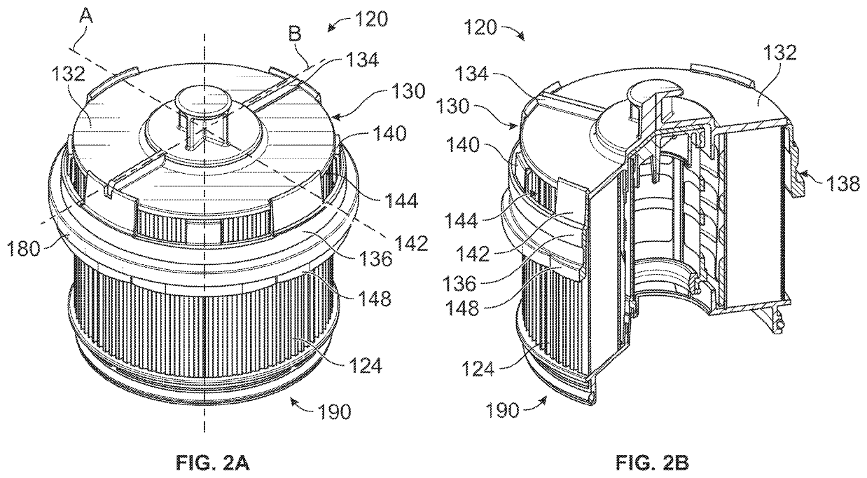

Now referring to FIGS. 2A and 2B, a perspective view and a cutaway perspective view of the filter element 120 are shown according to an example embodiment. As briefly described above, the filter element 120 includes a filter media 124, a first endplate 130, and a second endplate 190. The first endplate 130 includes the first endplate first portion 132 and the first endplate second portion 136.

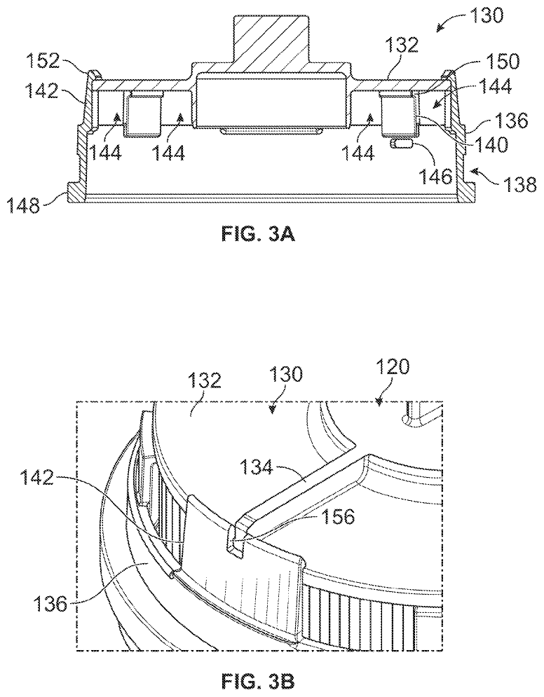

In the embodiment shown, the first endplate first portion 132 includes one or more ribs 134 that extend radially from a center of the first endplate first portion 132 to an edge of the first endplate first portion 132. The one or more ribs 134 are part of an anti-rotation feature described herein with respect to FIG. 3B.

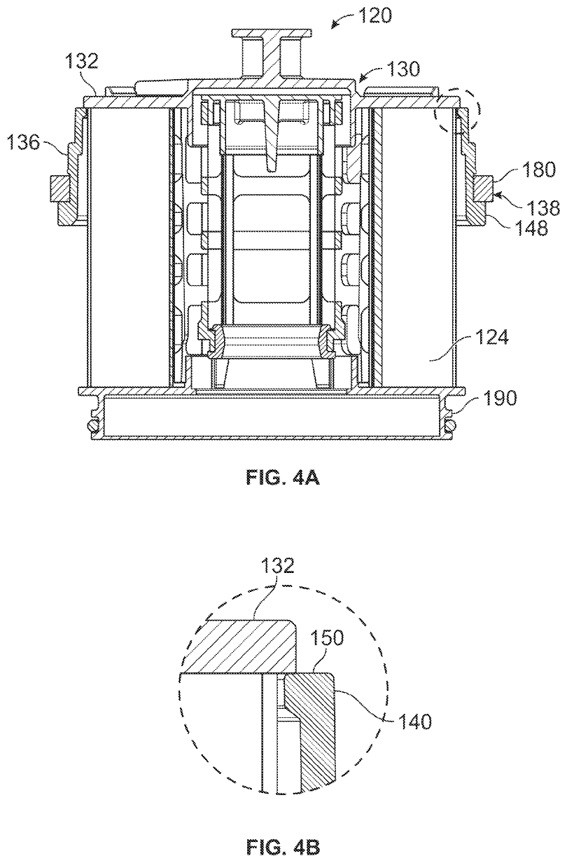

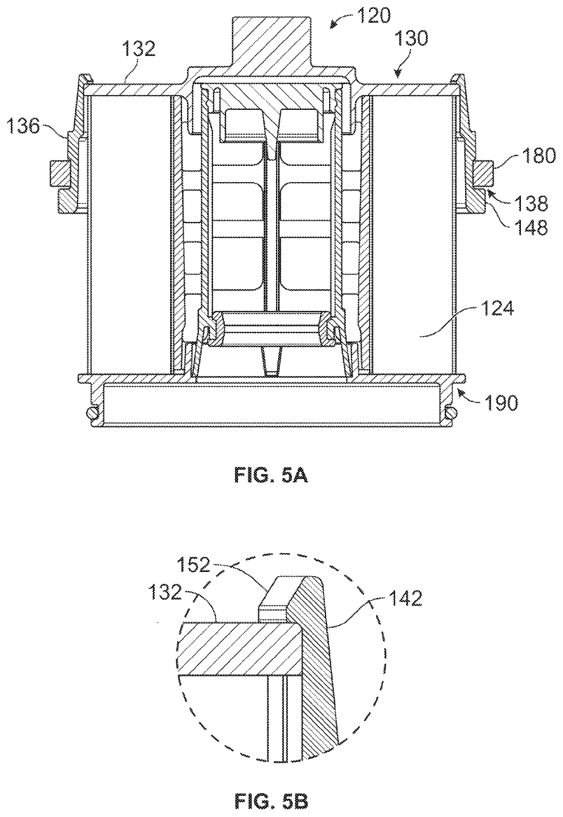

The first endplate second portion 136 includes one or more first engagement structures 140 and one or more second engagement structures 142. The one or more first engagement structures 140 and the one or more second engagement structures 142 extend axially away from the first endplate second portion 136 towards the first endplate first portion 132. The one or more first engagement structures 140 and the one or more second engagement structures 142 are circumferentially spaced from each other by such that a gap 144 is defined between the one or more first engagement structures 140 and the one or more second engagement structures 142. The fluid may flow through the gaps 144 between the one or more first engagement structures 140 and one or more second engagement structures 142. The one or more first engagement structures 140 and the one or more second engagement structures 142 couple the first endplate second portion 136 to the first endplate first portion 132 in a snap fit arrangement. As described herein, the one or more first engagement structures 140 and the one or more second engagement structures 142 couple the first endplate second portion 136 to the first endplate first portion 132 such that the first endplate first portion 132 may move relative to the first endplate second portion 136. The one or more first engagement structures 140 and one or more second engagement structures 142 are described in more detail herein below with respect to FIGS. 4B and 5B.

In the embodiment shown, the first endplate second portion 136 also includes an interlocking interface 148 for positioning the filter element within the filter head 102 and/or the shell 108. The interlocking interface 148 extends radially away from the first endplate second portion 136. The interlocking interface 148 includes an outer wall that extends around the circumference of the first endplate second portion 136. The outer wall includes a top surface, a bottom surface, and an outer surface. The top surface and the bottom surface are substantially parallel to each other and extend in a radial direction, away from the first endplate second portion 136. The outer surface is substantially perpendicular to the top surface and the bottom surface. The outer surface may have an undulating or repeating pattern that matches a complementary pattern of an inner surface of the shell 108 such that the interlocking interface 148 aligns the filter element 120 within the shell 108. The interlocking interface 148 further prevents non-authorized filter elements from being installed in the filtration system, for example, by preventing a non-matching pattern from fitting within the shell 108. Additionally, the undulating pattern of the interlocking interface 148 may prevent the filter element 120 from freely rotating with respect to the shell 108. In other embodiments, the first endplate second portion 136 of the interlocking interface 148 may be substantially circular or annular in shape. In these embodiments, the interlocking interface 148 does not prevent the filter element 120 from rotating relative to the shell 108.

In any of the above described embodiments, the interlocking interface 148 at least partially defines the endplate sealing surface 138. The endplate sealing surface 138 extends around a circumference of the first endplate second portion 136, above the interlocking interface 148. As briefly described above, the endplate sealing surface 138 may support the seal member 180, such that the seal member 180 moves with the first endplate second portion 136.

FIG. 3A is a sectional view of the first endplate 130. As described above, the first endplate 130 includes the first endplate first portion 132 and the first endplate second portion 136. The first endplate second portion 136 includes the one or more first engagement structures 140, the one or more second engagement structures 142, the endplate sealing surface 138, and the interlocking interface 148.

The one or more first engagement structures 140 each include a first engagement structure first end 150 that is disposed at a bottom surface of the first endplate first portion 132. The first engagement structure first end 150 also extends in a radially inward direction. The one or more second engagement structures 142 each include a second engagement structure first end 152 that extends axially above the first endplate first portion 132. The second engagement structure first end 152 also extends in a radially inward direction. The first endplate first portion 132 is at least partially retained between the one or more first engagement structures 140 and the one or more second engagement structures 142. More specifically, the first endplate first portion 132 is at least partially retained between the first engagement structure first end 150 of the one or more first engagement structures 140 and the second engagement structure first end 152 of the one or more second engagement structures 142. According to an example embodiment, the first endplate first portion 132 is loosely retained between the one or more first engagement structures 140 and the one or more second engagement structures 142 such that the first endplate first portion 132 and the first endplate second portion 136 may move relative to each other. The relative movement of the first endplate first portion 132 and the first endplate second portion 136 may be limited in the axial direction by the radially inward portions of the first engagement structure first end 150 and the second engagement structure first end 152. The relative movement of the first endplate first portion 132 and the first endplate second portion 136 may be limited in the radial direction by the axial portions of the first engagement structure 140 and the second engagement structure 142.

In some embodiments, the first endplate second portion 136 is substantially stationary during operation of the filtration system 100. For example, the first endplate second portion 136 may be held in place by the interaction between the filter head 102, the shell 108, and the seal member 180 with the endplate sealing surface 138. Accordingly, the first endplate first portion 132 may move relative to the first endplate second portion 136. For example, during operation of the filtration system 100, fluid pressure may impart a force on the first endplate first portion 132 or a component of the filtration system 100 fixed to the first endplate first portion 132, such as the filter media 124. The force imparted by the fluid pressure may cause the first endplate first portion 132 to move relative to the filter head 102 and the shell 108. The loose coupling of the first endplate first portion 132 and the first endplate second portion 136 enables the first endplate second portion 136 to remain stationary relative to the filter head 102 and the shell 108, advantageously reducing stress on the seal member 180.

In the embodiment shown in FIG. 3A, the first endplate second portion 136 also includes a fluid port 146. The fluid port 146 allows a fluid to flow between an outside of the first endplate second portion 136 and an inside of the first endplate second portion 136. In other embodiments, the first endplate second portion 136 does not include the fluid port 146.

FIG. 3B is a detailed perspective view of the filter element 120 of FIG. 2A showing a portion of the first endplate 130. As shown, the rib 134 extends to a radial edge of the first endplate first portion 132. At least one of the one or more second engagement structures 142 includes a groove 156 that extends radially through the one or more second engagement structures 142. The groove 156 is sized to receive at least a portion of the rib 134. The rib 134 is radially aligned with the groove 156 such that the groove 156 receives at least a portion of the rib 134. When the rib 134 is received by the groove 156, the first endplate first portion 132 is substantially prevented from rotating in the circumferential direction, relative to the first endplate second portion 136. Accordingly, the rib 134 and the groove 156 define an anti-rotation feature. As shown in FIG. 3B, the first endplate 130 includes two ribs 134 and two grooves 156. It should be understood that the first endplate 130 may include more or fewer (e.g., at least one) ribs 134 and grooves 156. In some embodiments, the rib 134 fits loosely within the groove 156 such that the first endplate first portion 132 may partially rotate in the circumferential direction, bounded by the difference between size of the groove 156 and the size of the rib 134. In other embodiments, the first endplate 130 does not include the rib 134 and the groove 156.

FIG. 4A is a first sectional view of the filter element 120 cut along line A-A in FIG. 2A. FIG. 4B is a first detailed sectional view of the sectional view shown in FIG. 4A, showing the first engagement structure 140. As briefly described above, the first engagement structure 140 extends axially away from the first endplate second portion 136 and towards the first endplate first portion 132. More specifically, the first engagement structure 140 includes a first axial wall that extends axially away from a top surface of the first endplate second portion 136 and towards a bottom surface of the first endplate first portion 132. The first axial wall of the first engagement structure 140 may at least partially extend radially inward from the first endplate second portion 136. An outer surface of the first axial wall may be curved to match the curvature of the first endplate second portion 136.

The first engagement structure first end 150 extends radially inward from a top portion of the first axial wall such that the first engagement structure first end 150 loosely contacts the bottom surface of the first endplate first portion 132. More specifically, the first engagement structure first end 150 includes a radial wall that extends radially inward from the first axial wall and axially below the bottom surface of the first endplate first portion 132. The radial wall is substantially perpendicular to the first axial wall. At least a portion of a top surface of the radial wall loosely contacts the bottom surface of the first endplate first portion 132. For example, a radially outward portion of the first engagement structure first end 150 may not contact the first endplate first portion 132 and a radially inward portion of the first engagement structure first end 150 may contact the first endplate first portion 132.

FIG. 5A is a second sectional view of the filter element 120 cut along line B-B in FIG. 2A. FIG. 5B is a second detailed sectional view the sectional view shown in FIG. 5A, showing the second engagement structure 142. As briefly described above, the second engagement structure 142 extends axially away from the first endplate second portion 136 and above the first endplate first portion 132. More specifically, second engagement structure 142 includes a second axial wall that extends axially away from a top portion of the first endplate second portion 136 and above a top surface of the first endplate first portion 132 and radially outward from the first endplate first portion 132.

The second engagement structure first end 152 extends radially inward from a top portion of the second axial wall such that the second engagement structure first end 152 loosely contacts a top surface of the first endplate first portion 132. More specifically, the second engagement structure first end 152 includes a tab that extends radially inward from the second axial wall of the second engagement structure 142 and axially above the first endplate first portion 132, such that the tab is substantially above a top surface of the first endplate first portion 132. At least a portion of a bottom surface of the tab loosely contacts the top surface of the first endplate first portion 132. When the first endplate first portion 132 is coupled to the first endplate second portion 136, the second engagement structure may deflect away from the first endplate first portion 132 and “snap” back to the original position (e.g., a cantilever snap-fit).

Now referring to FIGS. 6A-6C, additional views of the components of the filter element 120 are shown. Specifically, FIG. 6A is a perspective view of the first endplate first portion 132. As described herein, the first endplate first portion 132 may be fixed to the filter media 124 by an embedding processes. The embedding processes may include providing an adhesive or epoxy to the filter media 124 and/or the first endplate 130, coupling the filter media 124 to the first endplate 130, and providing an embedding flame to the first endplate 130 such that the epoxy cures and fixes the filter media 124 to the first endplate 130. The first endplate first portion 132 has a reduced wall thickness enabling the embedding flame to properly cure the epoxy. FIG. 6B is a perspective view of the first endplate second portion 136. FIG. 6C is a perspective view of the filter element 120 shown in a disassembled state. When the first endplate second portion 136 is coupled to the first endplate first portion 132, the one or more grooves 156 may be aligned with the one or more ribs 134.

### Press Fit Feature

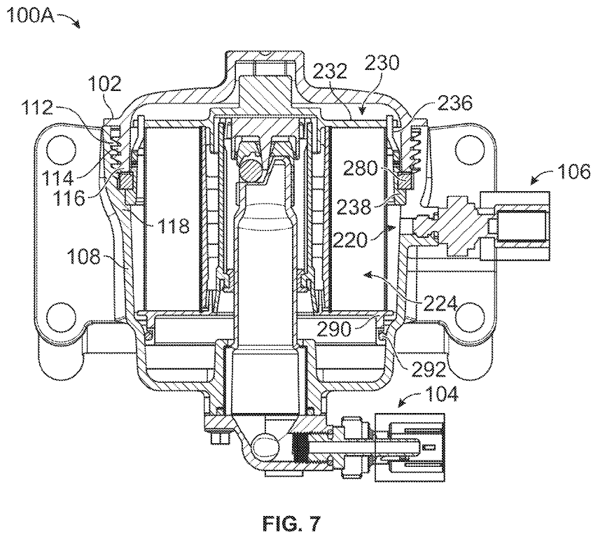

Referring generally to FIGS. 7-10C, various views of a filtration system 100A and components thereof are shown, according to various example embodiments. Referring first to FIG. 7, a sectional view of the filtration system 100A is shown, according to an example embodiment. The filtration system 100A shown in FIG. 7 is similar to the filtration system 100 of FIG. 1, except that the filtration system 100A of FIG. 7 includes a different filter element shown as filter element 220. For example, the filtration system 100A includes the filter head 102 and the shell 108. The filter head 102 and the shell 108 are described herein with respect to FIG. 1. The filtration system 100A also includes a filter element 220. It should be understood that the filtration system 100A may include more or fewer components than as shown in FIG. 7.

The filter element 220 is configured to filter a fluid (e.g., by removing contaminants). In some embodiments, the filter element 220 is removably coupled to the shell 108. In other embodiments, the filter element 220 is permanently secured within the shell 108 such that the filter element 220 cannot be removed from the shell 108 without causing damage to the filter element 220 and/or the shell 108. The filter element 220 is at least partially contained within the shell 108 and/or the filter head 102.

As shown, the filter element 220 includes a filter media 224, a first endplate 230, and a second endplate 290. The filter media 224 may be fitted between the first endplate 230 and the second endplate 290. In an example arrangement, the filter media 224 is embedded to the first endplate 230 by an embedding processes, such as the embedding processes described herein with respect to FIG. 6B. The filter media 224 may be similarly embedded to the second endplate 290. The filter media 224 may substantially similar to the filter media 124, described herein with respect to FIG. 1. For example, the filter media 224 may at least partially separate different types of fluid (e.g., separating water from fuel). It should be understood that the filter element 220 may include additional or different filter media than shown in FIG. 7. For example, the filter element 220 may include a second filter media, a coalescing media for coalescing water, and/or other filter media.

The first endplate 230 is positioned at a first end of the filter media 224. The first endplate 230 is shown to include a first endplate first portion 232 and a first endplate second portion 236. As described in more detail below, the first endplate first portion 232 is removably coupled to the first endplate second portion 236. The first endplate second portion 236 includes a first endplate sealing surface 238 that at least partially defines a cavity for a seal member 280. In some embodiments, the seal member 280 may press against the endplate sealing surface 238 and form a seal between the first endplate 230 and the filter head 102 and/or the shell 108. The second endplate 290 is positioned at a second end of the filter media 224, opposite the first end of the filter media 224. The second endplate 290 may include a second seal member 292 that forms a radial seal between the second endplate 290 and the shell 108.

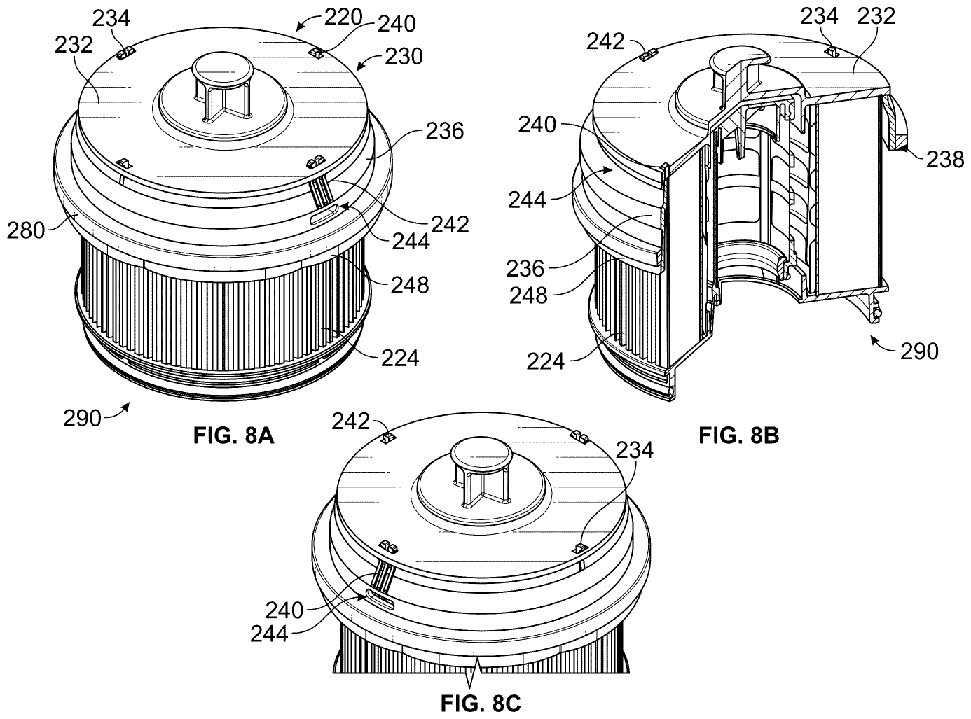

Now referring to FIGS. 8A-8C, various views of the filter element 220 are show, according to an example embodiment. As briefly described above, the filter element 220 includes a filter media 224, a first endplate 230, and a second endplate 290. The first endplate 230 includes the first endplate first portion 232 and the first endplate second portion 236.

In the embodiment shown, the first endplate first portion 232 includes openings 234 formed through the first endplate first portion 232. The openings 234 are positioned proximal a radial edge of the first endplate first portion 232. The openings 234 are circumferentially spaced from each other. The openings 234 are configured to receive at least one of a first engagement structure 240 and a second engagement structure 242.

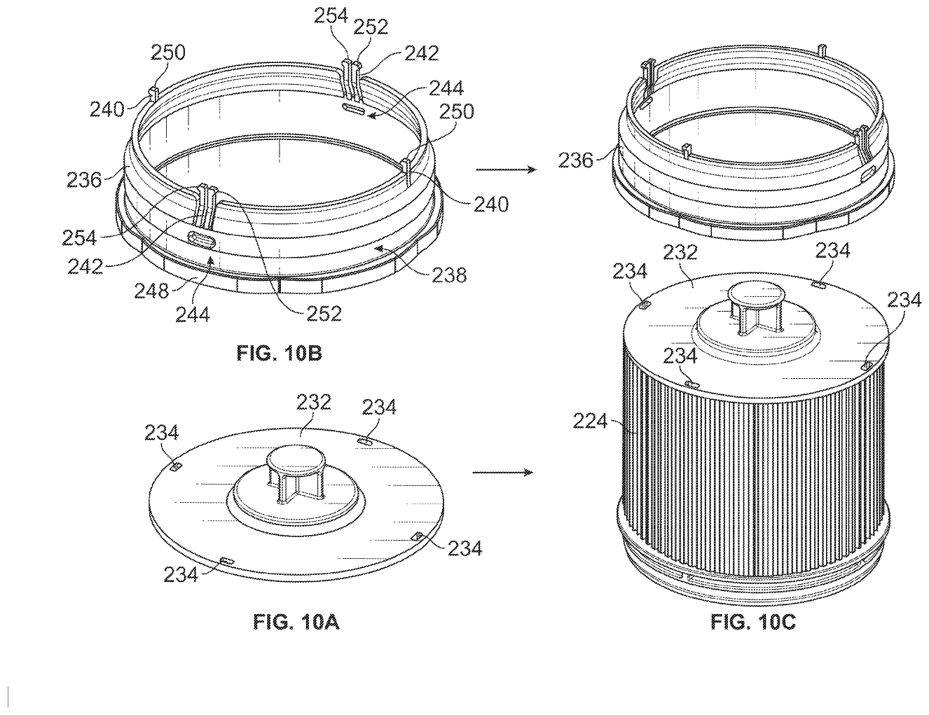

The first endplate second portion 236 includes one or more first engagement structures 240 and one or more second engagement structures 242. The one or more first engagement structures 240 and the one or more second engagement structures 242 extend axially away from the first endplate second portion 236 towards the first endplate first portion 232. The one or more first engagement structures 240 and the one or more second engagement structures 242 are circumferentially spaced from each other by such that the one or more first engagement structures 240 and the one or more second engagement structures 242 each align with a corresponding opening 234 of the first endplate first portion 232. The one or more first engagement structures 240 and the one or more second engagement structures 242 couple the first endplate second portion 236 to the first endplate first portion 232 in a press fit arrangement. As described herein, the one or more first engagement structures 240 and the one or more second engagement structures 242 couple the first endplate second portion 236 to the first endplate first portion 232 such that the first endplate first portion 232 may move relative to the first endplate second portion 236. Each of the one or more first engagement structures 240 and each of the one or more second engagement structures 242 extend through a corresponding opening 234 of the first endplate first portion 232. The one or more first engagement structures 240 and one or more second engagement structures 242 are described in more detail herein below with respect to FIGS. 10A-10B.

The first endplate second portion 236 may also include one or more fluid ports 244. The fluid port 244 allows a fluid to flow between an outside of the first endplate second portion 236 and an inside of the first endplate second portion 236. In other embodiments, the first endplate second portion 236 does not include the fluid port 244.

In the embodiment shown, the first endplate second portion 236 also includes an interlocking interface 248 for positioning the filter element within the filter head 102 and/or the shell 108. The interlocking interface 248 is substantially similar to the interlocking interface 148, described herein, with respect to FIGS. 2A and 2B. The interlocking interface 248 at least partially defines the endplate sealing surface 238. The endplate sealing surface 238 supports the seal member 280, such that the seal member 280 moves with the first endplate second portion 236.

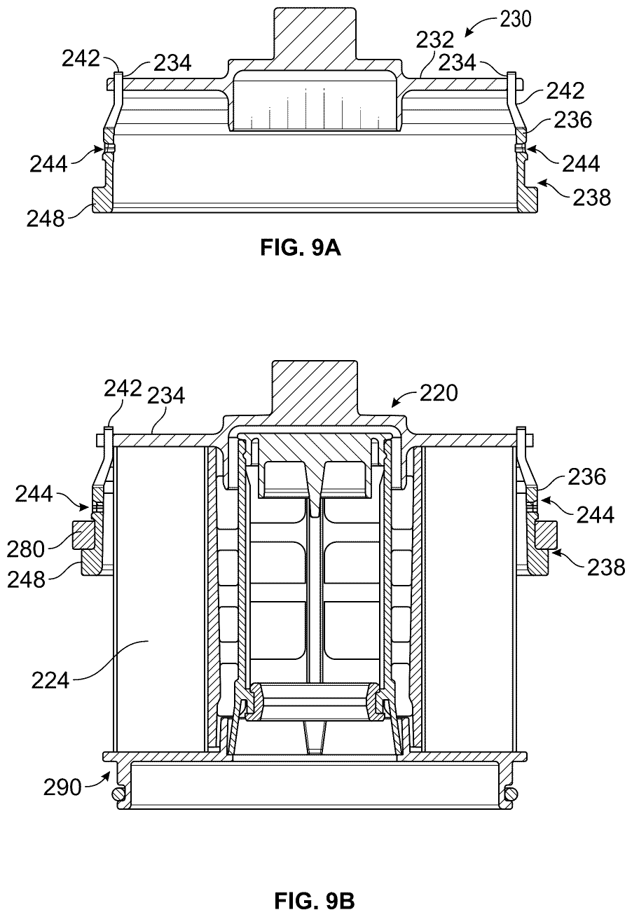

FIG. 9A is a sectional view of the first endplate 230 for use with the filter element 220 of FIG. 7. As described above, the first endplate 230 includes the first endplate first portion 232 and the first endplate second portion 236. The first endplate second portion 236 includes the one or more first engagement structures 240, the one or more second engagement structures 242, the endplate sealing surface 238, and the interlocking interface 248. FIG. 9B is a sectional view of the filter element 120 of FIG. 8A. As shown in FIGS. 9A and 9B, the second engagement structures 242 include an oblique member that extends away from the first endplate second portion 236 in an oblique direction, axially upward and radially inwards. The oblique member of the second engagement structures 242 does not align with the openings 234 such that the oblique member of the second engagement structures 242 prevents the first endplate first portion 232 from moving in an axially downward direction. Although not shown in FIGS. 9A and 9B, the first engagement structures 240 may include a similar oblique member that similarly extend in an oblique direction (e.g., axially upward and radially inwards), such that the oblique member of the first engagement structures 240 prevents the first endplate first portion 232 from moving in an axially downward direction.

Now referring to FIGS. 10A-10C, additional views of the components of the filter element 220 are shown. Specifically, FIG. 10A is a perspective view of the first endplate first portion 232. As briefly described above, the first endplate first portion 232 includes openings 234 for receiving the first engagement structures 240 and/or the second engagement structures 242. As shown the first endplate first portion 232 includes four openings 234. In other embodiments, the first endplate first portion 232 may include more or fewer openings 234 (e.g., at least one opening 234).

Now referring to FIG. 10B, a perspective view of the first endplate second portion 236 is shown. As described above, the first endplate second portion 236 includes the first engagement structures 240 and the second engagement structures 242. As shown the first endplate second portion 236 includes two first engagement structures 240 and two second engagement structures 242. In other embodiments, the first endplate second portion 236 may include more or fewer first engagement structures 240 and second engagement structures 242 (e.g., at least one first engagement structure 240 and at least one second engagement structure 242). In yet other embodiments, the first endplate second portion 236 may include only the first engagement structures 240 (e.g., at least one first engagement structure 240) or only the second engagement structures 242 (e.g., at least one second engagement structure 242). All such variations are intended to fall within the scope of this disclosure.

The one or more first engagement structures 240 each include an elongated member and a first engagement structure first end 250. The elongated member extends axially away from the first endplate second portion 236. When the first endplate second portion 236 is coupled to the first endplate first portion 232, the elongated member extends through a corresponding opening 234. The first engagement structure first end 250 is disposed at an axial end of the elongated member, axially away from the first endplate second portion 236, such that, when the first endplate second portion 236 is coupled to the first endplate first portion 232, the first engagement structure first end 250 is disposed above the first endplate first portion 232. The first engagement structure first end 250 includes a radial lip that extends in a radial direction. As shown in FIG. 10B, the radial lip of the first engagement structure first end 250 extends in a radially outward direction. In other embodiments, the radial lip of the first engagement structure first end 250 may extend in a radially inward direction. As described in more detail herein, the first engagement structure first end 250 retains the first endplate first portion 232. More specifically, the radial lip of the first engagement structure first end 250 retains the first endplate first portion 232 by preventing the first endplate first portion 232 from moving in an axially upward direction (e.g., away from the first endplate second portion 236). For example, the lip of the first engagement structure first end 250 may loosely contact a top surface of the first endplate first portion 232 by preventing the first endplate first portion 232 from moving in the axially upward direction.

The one or more second engagement structures 242 each include an oblique member, an example of which is described above with respect to FIGS. 9A and 9B, a second engagement structure first portion 252, and a second engagement structure second portion 254. As described above, the oblique member is not aligned with the openings 234 such that the oblique member prevents the first endplate first portion from moving axially downward (e.g., towards the first endplate second portion 236). The second engagement structure first portion 252 includes a first prong and the second engagement structure second portion 254 includes a second prong. The first prong and the second prong extend axially away from the first endplate second portion 236, such that, when the first endplate second portion 236 is coupled to the first endplate first portion 232, the first elongated member and the second elongated member extend through a corresponding opening 234 of the first endplate first portion 232. The second engagement structure first portion 252 also includes a first tangential lip, and the second engagement structure second portion 254 also includes a second tangential lip. The first tangential lip and the second tangential lip extend in a circumferential or tangential direction. As shown in FIG. 10B, the first tangential lip of the second engagement structure first portion 252 extends in a first tangential direction, and the second tangential lip of the second engagement structure second portion 254 extends in a second tangential direction, opposite the first tangential direction.

The first endplate first portion 232 is at least partially retained by the first engagement structures 240 and the second engagement structures 242. More specifically, the first endplate first portion 232 is at least partially retained by the first engagement structure first end 250 of the one or more first engagement structures 240 and the second engagement structure first portion 252 and the second engagement structure second portion 254 of the one or more second engagement structures 242. According to an example embodiment, the first endplate first portion 232 is loosely retained by the one or more first engagement structures 240 and the one or more second engagement structures 242 such that the first endplate first portion 232 and the first endplate second portion 236 may move relative to each other.

The relative movement of the first endplate first portion 232 and the first endplate second portion 236 may be limited in an axially upward direction by the radial lip of the first engagement structure first end 250, the first tangential lip of the second engagement structure first portion 252, and the second tangential lip of the second engagement structure second portion 254. More specifically, the radial lip, the first tangential lip, and/or the second tangential lip loosely contacting a top surface of the first endplate first portion 232 limits movement of the first endplate first portion 232 in the axially upward direction. The relative movement of the first endplate first portion 232 and the first endplate second portion 236 may be limited in an axially downward direction by the oblique member of the second engagement structures 242, as described above with respect to FIGS. 9A and 9B. In some embodiments, the relative movement of the first endplate first portion 232 and the first endplate second portion 236 may be limited in an axially downward direction by the oblique member of the first engagement structures 240, as described above with respect to FIGS. 9A and 9B.

The relative movement of the first endplate first portion 232 and the first endplate second portion 236 may be limited in the radial direction by a difference in the size of the openings 234 and the elongated member of the first engagement structure 240 and the first prong and the second prong of the second engagement structure 242. The relative movement of the first endplate first portion 232 and the first endplate second portion 236 may be limited in the circumferential direction by a difference in the size of the openings 234 and the elongated member of the first engagement structure 240 and the first prong and the second prong of the second engagement structure 242. More specifically, the openings 234 may be larger than the elongated member of the first engagement structure 240 and/or the first prong and the second prong of the second engagement structure 242 in the radial direction and/or in the circumferential direction. The difference in size between the openings 234 and first engagement structure 240 and/or the first prong and the second prong of the second engagement structure 242 in the radial direction and/or in the circumferential direction bounds the movement of the first endplate first portion 232 relative to the first endplate second portion 236.

In some embodiments, the first endplate second portion 236 is substantially stationary during operation of the filtration system 100A. For example, the first endplate second portion 236 may be held in place by the interaction between the filter head 102, the shell 108, and the seal member 280 with the endplate sealing surface 238. Accordingly, the first endplate first portion 232 may move relative to the first endplate second portion 236. For example, during operation of the filtration system 100A, fluid pressure may impart a force on the first endplate first portion 232 or a component of the filtration system 100A fixed to the first endplate first portion 232, such as the filter media 224. The force imparted by the fluid pressure may cause the first endplate first portion 232 to move relative to the filter head 102 and the shell 108. The loose coupling of the first endplate first portion 232 and the first endplate second portion 236 enables the first endplate second portion 236 to remain stationary relative to the filter head 102 and the shell 108 advantageously reducing stress on the seal member 280.

FIG. 10C is a perspective view of the filter element 220 shown in a disassembled state. When the first endplate second portion 236 is coupled to the first endplate first portion 232, the first engagement structures 240 and the second engagement structures 242 each align with a corresponding opening 234.

### Threading Feature

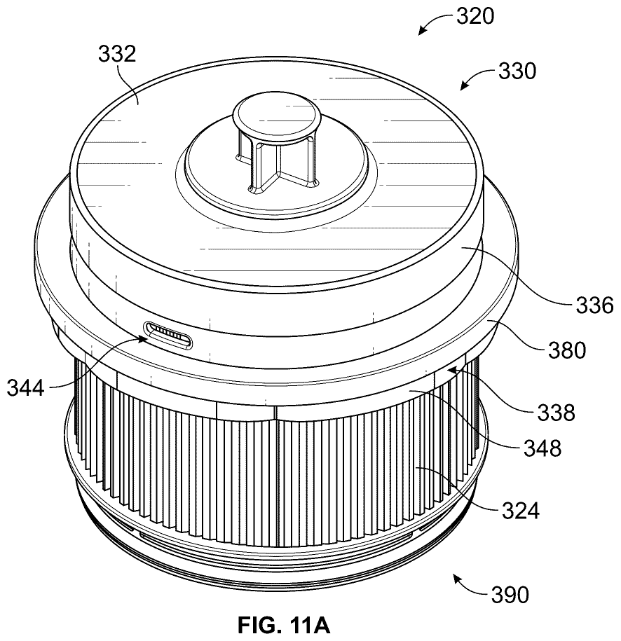

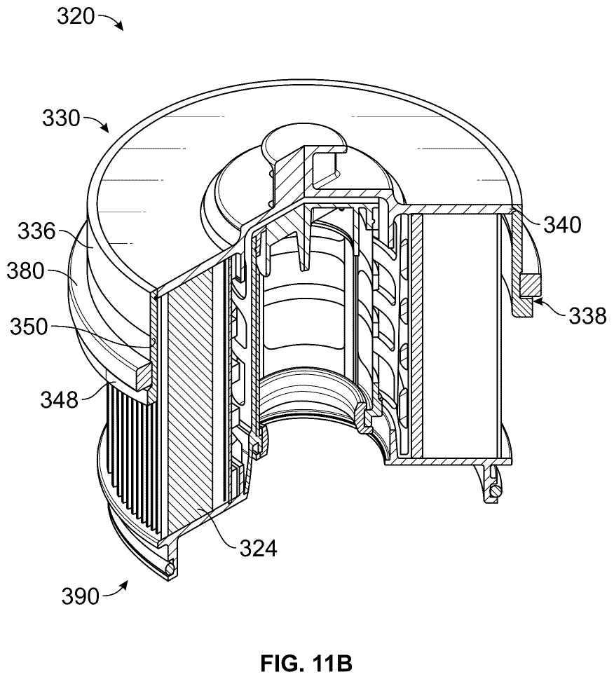

Now referring to FIGS. 11A-11B various views of a filter element 320 are shown, according to another example embodiment. The filter element 320 is configured for use in any of the filtration systems 100, 100A, etc. described herein. The filter element 320 is configured to filter a fluid (e.g., by removing contaminants). In some embodiments, the filter element 320 is removably coupled to the shell 108 of the filtration system 100, 100A. In other embodiments, the filter element 320 is permanently secured within the shell 108 such that the filter element 320 cannot be removed from the shell 108 without causing damage to the filter element 320 and/or the shell 108. The filter element 320 is at least partially contained within the shell 108 and/or the filter head 102 of the filtration system 100, 100A.

As shown, the filter element 320 includes a filter media 324, a first endplate 330, and a second endplate 390. The filter media 324 may be fitted between the first endplate 330 and the second endplate 390. In an example arrangement, the filter media 324 is embedded to the first endplate 330 by an embedding processes, such as the embedding processes described herein with respect to FIG. 6B. The filter media 324 may be similarly embedded to the second endplate 390. The filter media 324 may substantially similar to the filter media 124, described herein with respect to FIG. 1. For example, the filter media 324 may at least partially separate different types of fluid (e.g., separating water from fuel). It should be understood that the filter element 320 may include additional or different filter media than shown in FIGS. 11A and 11B. For example, the filter element 320 may include a second filter media, a coalescing media for coalescing water, and/or other filter media.

The first endplate 330 is positioned at a first end of the filter media 324. The first endplate 330 is shown to include a first endplate first portion 332 and a first endplate second portion 336. As described in more detail below, the first endplate first portion 332 is removably coupled to the first endplate second portion 336. The first endplate second portion 336 includes a first endplate sealing surface 338 that at least partially defines a cavity for a seal member 380. In some embodiments, the seal member 380 may press against the endplate sealing surface 338 and form a seal between the first endplate 330 and the filter head 102 and/or the shell 108 of the filtration system 100, 100A. The second endplate 390 is positioned at a second end of the filter media 324, opposite the first end of the filter media 324. The second endplate 390 may include a second seal member 392 that forms a radial seal between the second endplate 290 and the shell 108 of the filtration system 100, 100A.

In the embodiment shown in FIG. 11B, the first endplate first portion 332 includes a first endplate first portion engagement structure shown as one or more first threads 340. The one or more first threads 340 extend radially outward from a radial edge of the first endplate first portion 332 and around the circumference of the first endplate first portion 332 in a helical pattern. The one or more first threads 340 are configured as external threads or “male” threads.

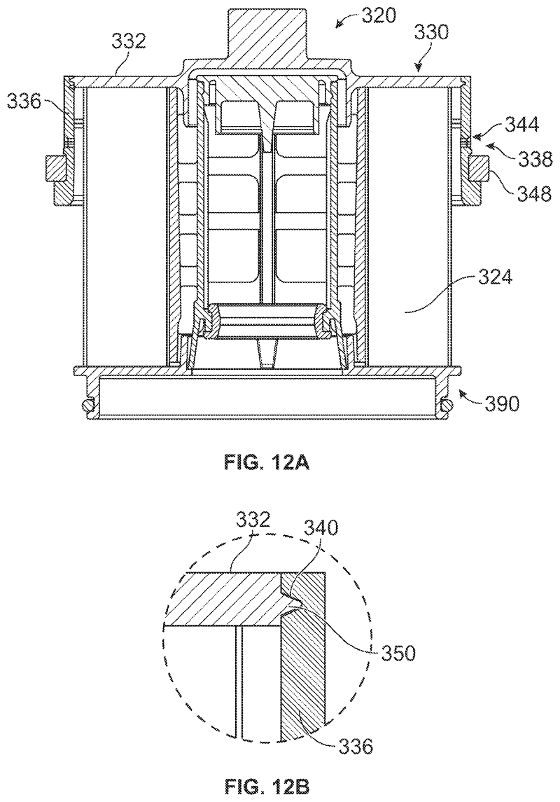

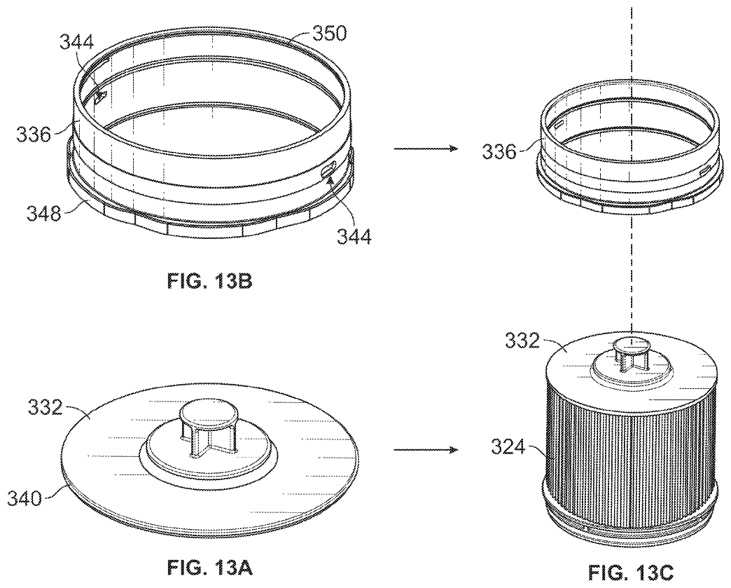

The first endplate second portion 336 includes a first endplate second portion engagement structure shown as one or more second threads 350. The one or more second threads 350 are disposed on an inner surface of the first endplate second portion 336 and extend around the inner circumference of the first endplate second portion 336 in a helical pattern. The one or more second threads 350 are configured as internal threads or “female” threads. The one or more second threads 350 are configured to receive the one or more first threads 340 such that the one or more first threads 340 and the one or more second threads 350 couple the first endplate second portion 336 to the first endplate first portion 332 in a threaded engagement. As described herein, the one or more first threads 340 and the one or more second threads 350 couple the first endplate second portion 336 to the first endplate first portion 332 such that the first endplate first portion 332 may move relative to the first endplate second portion 336. The one or more first threads 340 and the one or more second threads 350 are described in more detail herein below with respect to FIGS. 12A-12B.

The first endplate second portion 336 may also include one or more fluid ports 344. The fluid port 344 allows a fluid to flow between an outside of the first endplate second portion 336 and an inside of the first endplate second portion 336. In other embodiments, the first endplate second portion 336 does not include the fluid port 344.

In the embodiment shown, the first endplate second portion 336 also includes an interlocking interface 348 for positioning the filter element within the filter head 102 and/or the shell 108 of the filtration system 100, 100A. The interlocking interface 348 is substantially similar to the interlocking interface 148, described herein, with respect to FIGS. 2A and 2B. The interlocking interface 348 at least partially defines the endplate sealing surface 338. The endplate sealing surface 338 supports the seal member 380, such that the seal member 380 moves with the first endplate second portion 336.

FIG. 12A is a sectional view of the filter element 320. FIG. 12B is a detailed sectional view of the sectional view shown in FIG. 12A, showing the one or more first threads 340 and the one or more second threads 350. As briefly described above, the one or more first threads 340 are external threads extending radially away from the first endplate first portion 332 and towards the first endplate second portion 336. The one or more second threads 350 are internal threads configured to receive the one or more first threads 340. The one or more second threads 350 are sized such that the one or more first threads 340 loosely fit within the one or more second threads 350. The first endplate first portion 332 is loosely coupled to the first endplate second portion 336 by the one or more first threads 340 and the one or more second threads 350 such that the first endplate first portion 332 and the first endplate second portion 336 may move relative to each other. The relative movement of the first endplate first portion 332 and the first endplate second portion 336 may be limited in the axial direction by a difference in axial size between the one or more first threads 340 and the one or more second threads 350. The relative movement of the first endplate first portion 332 and the first endplate second portion 336 may be limited in the radial direction by an external surface of the first endplate first portion 332 and an internal surface of the first endplate second portion 336.

Now referring to FIGS. 13A-13C, additional views of the components of the filter element 320 are shown. Specifically, FIG. 13A is a perspective view of the first endplate first portion 332. As described herein, the first endplate first portion 332 may be fixed to the filter media 324 by an embedding processes, such as the embedding process described herein with respect to FIG. 6A. FIG. 13B is a perspective view of the first endplate second portion 336. FIG. 13C is a perspective view of the filter element 320 shown in a disassembled state. When the first endplate second portion 336 is coupled to the first endplate first portion 332, the one or more second threads 350 may receive the one or more first threads 340.

### Locate, Rotate, & Fix Feature

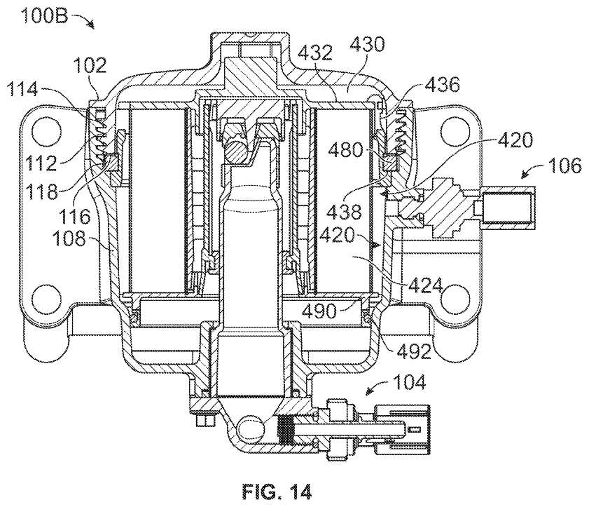

Referring generally to FIGS. 14-16C, various views of a filtration system 100B and components thereof are shown, according to various example embodiments. Referring first to FIG. 14, a sectional view of the filtration system 100B is shown, according to an example embodiment. The filtration system 100B shown in FIG. 14 is similar to the filtration system 100 of FIG. 1, except that the filtration system 100B of FIG. 14 includes a different filter element shown as filter element 420. For example, the filtration system 100B includes the filter head 102 and the shell 108. The filter head 102 and the shell 108 are described herein with respect to FIG. 1. The filtration system 100B also includes a filter element 420. It should be understood that the filtration system 100B may include more or fewer components than as shown in FIG. 14.

The filter element 420 is configured to filter a fluid (e.g., by removing contaminants). In some embodiments, the filter element 420 is removably coupled to the shell 108. In other embodiments, the filter element 420 is permanently secured within the shell 108 such that the filter element 420 cannot be removed from the shell 108 without causing damage to the filter element 420 and/or the shell 108. The filter element 420 is at least partially contained within the shell 108 and/or the filter head 102.

As shown, the filter element 420 includes a filter media 424, a first endplate 430, and a second endplate 490. The filter media 424 may be fitted between the first endplate 430 and the second endplate 490. In an example arrangement, the filter media 424 is embedded to the first endplate 430 by an embedding processes, such as the embedding processes described herein with respect to FIG. 6B. The filter media 424 may be similarly embedded to the second endplate 490. The filter media 424 may substantially similar to the filter media 124, described herein with respect to FIG. 1. For example, the filter media 424 may at least partially separate different types of fluid (e.g., separating water from fuel). It should be understood that the filter element 420 may include additional or different filter media than shown in FIG. 14. For example, the filter element 420 may include a second filter media, a coalescing media for coalescing water, and/or other filter media.

The first endplate 430 is positioned at a first end of the filter media 424. The first endplate 430 is shown to include a first endplate first portion 432 and a first endplate second portion 436. As described in more detail below, the first endplate first portion 432 is removably coupled to the first endplate second portion 436. The first endplate second portion 436 includes a first endplate sealing surface 438 that at least partially defines a cavity for a seal member 480. In some embodiments, the seal member 480 may press against the endplate sealing surface 438 and form a seal between the first endplate 430 and the filter head 102 and/or the shell 108. The second endplate 490 is positioned at a second end of the filter media 424, opposite the first end of the filter media 424. The second endplate 490 may include a second seal member 492 that forms a radial seal between the second endplate 490 and the shell 108.

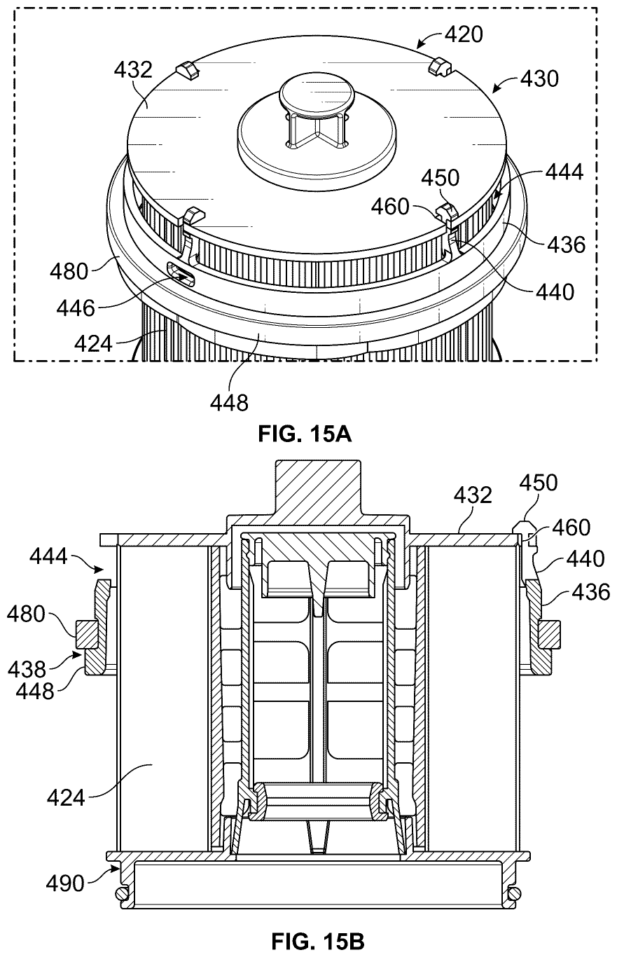

Now referring to FIGS. 15A and 15B, various views of the filter element 420 are shown, according to an example embodiment. Specifically, FIG. 15A, is a detailed perspective view of the filter element 420 showing the first endplate 430, and FIG. 15B is a cutaway perspective view showing the filter element 420. As briefly described above, the filter element 420 includes a filter media 424, a first endplate 430, and a second endplate 490. The first endplate 430 includes the first endplate first portion 432 and the first endplate second portion 436.

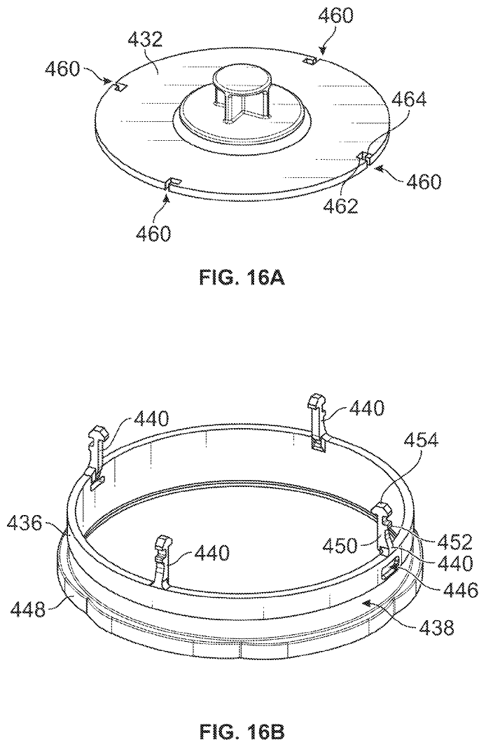

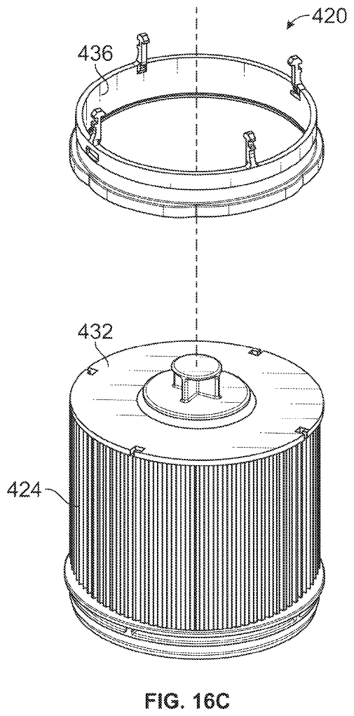

In the embodiment shown, the first endplate first portion 432 includes channels 460 that extend radially inwards from an outer edge of the first endplate first portion 432 and at least partially towards the center of the first endplate first portion 432. The channels 460 are part of a locate, rotate, and fix feature, described herein in detail with respect to FIGS. 16A-16B.

The first endplate second portion 436 includes one or more first engagement structures 440. The one or more first engagement structures 440 extend axially away from the first endplate second portion 436 towards the first endplate first portion 432. The one or more first engagement structures 440 are circumferentially spaced from each other by such that a gap 444 is defined between the one or more first engagement structures 440. The fluid may flow through the gaps 444, between the one or more first engagement structures 440. The one or more first engagement structures 440 are received by a respective channel 460 to couple the first endplate second portion 436 to the first endplate first portion 432 in a locate, rotate, and fix arrangement. As described herein, the one or more first engagement structures 440 couple the first endplate second portion 436 to the first endplate first portion 432 such that the first endplate first portion 432 may move relative to the first endplate second portion 436. The channels 460 and the one or more first engagement structures 440 are described in more detail herein below with respect to FIGS. 16A and 16B.

In the embodiment shown, the first endplate second portion 436 also includes an interlocking interface 448 for positioning the filter element within the filter head 102 and/or the shell 108 of the filtration system 100B. The interlocking interface 448 may be substantially similar or the same as the interlocking interface 148 of FIG. 2A. The interlocking interface 448 at least partially defines the endplate sealing surface 438. As briefly described above, the endplate sealing surface 438 may support the seal member 480, such that the seal member 480 moves with the first endplate second portion 436.

Now referring to FIGS. 16A-16C, additional views of the components of the filter element 420 are shown. Specifically, FIG. 16A is a perspective view of the first endplate first portion 432. As briefly described above, the first endplate first portion 432 includes channels 460 for receiving the first engagement structures 440. As shown the first endplate first portion 432 includes four channels 460. In other embodiments, the first endplate first portion 432 may include more or fewer channels 460 (e.g., at least one channels 460). Each of the channels 460 include a first channel portion 462 and a second channel portion 464. The first channel portion 462 extends radially inward from an outer edge of the first endplate first portion 432 and at least partially towards the center of the first endplate first portion 432. The second channel portion 464 extends away from the first channel portion 462 in a circumferential direction. Together, the first channel portion 462 and the second channel portion 464 define an “L” shaped channel 460.

Now referring to FIG. 16B, a perspective view of the first endplate second portion 436 is shown. As described above, the first endplate second portion 436 includes the first engagement structures 440. As shown the first endplate second portion 436 includes four first engagement structures 440. In other embodiments, the first endplate second portion 436 may include more or fewer first engagement structures 440 (e.g., at least one first engagement structure 440).

The one or more first engagement structures 440 each include an extended portion 450. The extended portion 450 extends axially away from the first endplate second portion 436, such that, when the first endplate second portion 436 is coupled to the first endplate first portion 432, extended portion 450 at least partially extends through a corresponding channel 460 of the first endplate first portion 432. The first engagement structures 440 also include a lower flange 452 that extends radially away from the extended portion 450. As shown in FIG. 16B, the lower flange 452 extends in a radially outward direction. In other embodiments, the lower flange 452 may extend in a radially inward direction. The first engagement structures 440 also include an upper flange 454 disposed axially above the lower flange 452 and extends radially away from the extended portion 450. As shown in FIG. 16B, the upper flange 454 extends in both a radially outward direction and a radially inward direction. In other embodiments, the upper flange 454 may extend in one of a radially inward direction and a radially outward direction.

Now referring to FIG. 16C, a perspective view of the filter element 420 shown in a disassembled state. To couple the first endplate second portion 436 to the first endplate first portion 432, first, the first engagement structures 440 each align with a corresponding channel 460. Specifically, the upper flange 454 of the first engagement structure 440 aligns with the first channel portion 462 of a corresponding channel 460 such that the first endplate second portion 436 is located relative to the first endplate first portion 432. The extended portion 450 of the first engagement structure 440 extends at least partially through the corresponding channel 460 such that the upper flange 454 is above a top surface of the first endplate first portion 432 and the lower flange 452 is below a bottom surface of the first endplate first portion 432. Next the first endplate second portion 436 is rotated such that the extended portion 450 follows the second channel portion 464. In this position, the first endplate second portion 436 is fixed to the first endplate first portion 432. The locate, rotate, and fix feature includes the first engagement structures 440 and the channels 460.

The first endplate first portion 432 is at least partially retained by the first engagement structures 440. More specifically, the first endplate first portion 432 is at least partially retained by the extended portion 450 extending through the channels 460. Additionally, the first endplate first portion 432 is at least partially retained between the lower flange 452 and the upper flange 454. According to an example embodiment, the first endplate first portion 432 is loosely retained by the one or more first engagement structures 440 such that the first endplate first portion 432 and the first endplate second portion 436 may move relative to each other. The relative movement of the first endplate first portion 432 and the first endplate second portion 436 may be limited in an axially upward direction by the upper flange 454. The relative movement of the first endplate first portion 432 and the first endplate second portion 436 may be limited in an axially downward direction by the lower flange 452. The relative movement of the first endplate first portion 432 and the first endplate second portion 436 may be limited in the radial direction by a difference in the size of the channels 460 and the extended portion 450 extending through the channels 460. The relative movement of the first endplate first portion 432 and the first endplate second portion 436 may be limited in the circumferential direction by an end of the second channel portion 464 and the extended portion 450.

In some embodiments, the first endplate second portion 436 is substantially stationary during operation of the filtration system 100B. For example, the first endplate second portion 436 may be held in place by the interaction between the filter head 102, the shell 108, and the seal member 480 with the endplate sealing surface 438. Accordingly, the first endplate first portion 432 may move relative to the first endplate second portion 436. For example, during operation of the filtration system 100B, fluid pressure may impart a force on the first endplate first portion 432 or a component of the filtration system 100B fixed to the first endplate first portion 432, such as the filter media 424. The force imparted by the fluid pressure may cause the first endplate first portion 432 to move relative to the filter head 102 and the shell 108. The loose coupling of the first endplate first portion 432 and the first endplate second portion 436 enables the first endplate second portion 436 to remain stationary relative to the filter head 102 and the shell 108 advantageously reducing stress on the seal member 480.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “approximately” and similar terms are intended to have a broad meaning in harmony with the common and accepted usage by those of ordinary skill in the art to which the subject matter of this disclosure pertains. The term “approximately” as used herein refers to ±10% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein. While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filtration system comprising:
a filter housing comprising a shell and a filter head; and
a filter element positioned within the filter housing, the filter element comprising:
a filter media;
a first endplate positioned at a filter media first end, the first endplate comprising:
a first endplate first portion; and
a first endplate second portion comprising:
a first engagement structure coupling the first endplate second portion to the first endplate first portion such that the first endplate first portion is movable relative to the first endplate second portion while remaining coupled to the first endplate second portion.

2. The filtration system of claim 1, wherein the first endplate second portion further comprises a second engagement structure configured to couple the first endplate second portion to the first endplate first portion such that the first endplate first portion is movable relative to the first endplate second portion while remaining coupled to the first endplate second portion.

3. The filtration system of claim 2, wherein:
the first engagement structure comprises:
a first axial wall extending axially away from the first endplate second portion towards the first endplate first portion; and
a first engagement structure first end disposed at a first axial end of the first axial wall, the first engagement structure first end having a radial wall that extends radially inward from the first axial wall and axially below the first endplate first portion; and
the second engagement structure comprises:
a second axial wall extending axially away from the first endplate second portion and above the first endplate first portion; and
a second engagement structure first end disposed at a second axial end of the second axial wall, the second engagement structure first end having a tab that extends radially inward from the second axial wall and axially above the first endplate first portion.

4. The filtration system of claim 1, wherein the first engagement structure comprises:
an elongated member extending axially away from the first endplate second portion and through an opening of the first endplate first portion; and
a first engagement structure first end disposed at an axial end of the elongated member, the first engagement structure having a lip that extends above the first endplate first portion.

5. The filtration system of claim 1, wherein:
the first endplate first portion comprises an external thread; and
the first engagement structure comprises an internal thread configured to receive the external thread.

6. The filtration system of claim 1, wherein the first engagement structure comprises:
an extended portion, the extended portion extending axially away from the first endplate second portion and through a channel of the first endplate first portion;
a lower flange extending away from the extended portion and axially below the first endplate first portion; and
an upper flange extending away from the extended portion and axially above the first endplate first portion.

7. The filtration system of claim 1, wherein the first endplate second portion further comprises an endplate sealing surface that supports a seal member, the seal member contacting the filter housing and forming a seal between the shell and the filter head.

8. The filtration system of claim 1, wherein the first endplate second portion further comprises an interlocking interface, the interlocking interface including an outer surface having an undulating pattern preventing the filter element from rotating with respect to the shell.

9. A filter element comprising:
a filter media;
a first endplate positioned at a filter media first end, the first endplate comprising:
a first endplate first portion; and
a first endplate second portion comprising:
a first engagement structure coupling the first endplate second portion to the first endplate first portion such that the first endplate first portion is movable relative to the first endplate second portion while remaining coupled to the first endplate second portion.

10. The filter element of claim 9, wherein the first endplate second portion further comprises a second engagement structure configured to couple the first endplate second portion to the first endplate first portion such that the first endplate first portion is movable relative to the first endplate second portion while remaining coupled to the first endplate second portion.

11. The filter element of claim 10, wherein:
the first engagement structure comprises:
a first axial wall extending axially away from the first endplate second portion towards the first endplate first portion; and
a first engagement structure first end disposed at a first axial end of the first axial wall, the first engagement structure first end having a radial wall that extends radially inward from the first axial wall and axially below the first endplate first portion; and
the second engagement structure comprises:
a second axial wall extending axially away from the first endplate second portion and above the first endplate first portion; and
a second engagement structure first end disposed at a second axial end of the second axial wall, the second engagement structure first end having a tab that extends radially inward from the second axial wall and axially above the first endplate first portion.

12. The filter element of claim 9, wherein the first engagement structure comprises:
an elongated member extending axially away from the first endplate second portion and through an opening of the first endplate first portion; and
a first engagement structure first end disposed at an axial end of the elongated member, the first engagement structure having a lip that extends above the first endplate first portion.

13. The filter element of claim 9, wherein:
the first endplate first portion comprises an external thread; and
the first engagement structure comprises an internal thread configured to receive the external thread.

14. The filter element of claim 9, wherein the first engagement structure comprises:
an extended portion, the extended portion extending axially away from the first endplate second portion and through a channel of the first endplate first portion;
a lower flange extending away from the extended portion and axially below the first endplate first portion; and
an upper flange extending away from the extended portion and axially above the first endplate first portion.

15. The filter element of claim 9, wherein the first endplate second portion further comprises an interlocking interface, the interlocking interface including an outer surface having an undulating pattern that is configured to engage a filter shell.

16. An endplate for a filter element, the endplate comprising:
an endplate first portion comprising a rib that extends radially from a center of the endplate first portion to an edge of the endplate first portion;
an endplate second portion comprising:
a first wall extending away from a top surface of the endplate second portion and towards a bottom surface of the endplate first portion; and
a second wall extending away from the top surface of the endplate second portion and above the endplate first portion, the second wall having a groove that is sized to receive a portion of the rib such that the endplate first portion is coupled to the endplate second portion and the endplate first portion is movable relative to the endplate second portion while remaining coupled to the endplate second portion.

17. The endplate of claim 16, wherein the first wall at least partially extends radially inward from the endplate second portion such that a first end of the first wall is disposed at the bottom surface of the endplate first portion.

18. The endplate of claim 16, further comprising a tab that extends radially inward from the second wall and axially above the endplate first portion.

19. The endplate of claim 18, wherein a bottom surface of the tab loosely contacts a top surface of the endplate first portion such that the endplate first portion is movable relative to the endplate second portion while remaining coupled to the endplate second portion.

20. The endplate of claim 16, wherein the endplate second portion further comprises a fluid port that enables fluid to flow between an outside of the endplate second portion and an inside of the endplate second portion.
